(19) United States
(12) Patent Application Publication
(10) Pub. No.: US 2003/0164098 A1
(43) Pub. Date: Sep. 4, 2003

(54) Metal compactor with ball screw actuator

(76) Inventor: Ervin J. Bendzick, New Prague, MN (US)

Correspondence Address: Westman Champlin & Kelly, Suite 1600 - International Center, 900 Second Avenue South, Minneapolis, MN, 55402-3319, US

(21) Appl. No.: 10/182,250

(22) PCT Filed: Jan. 22, 2001
(86) PCT No.: PCT/US01/02079

(51) Int. Cl. B30B 1/00

(52) U.S. Cl. 100/193

(57) ABSTRACT

A metal chip and shaving compactor includes a compaction housing (80) having a compaction chamber (82) with a compaction piston (64) extending into the chamber Metal chips and shavings are admitted to the chamber through an inlet opening (84). Separate ball screw drive mechanisms (50 and 92, 94) move the piston and the compaction housing along an axis (58) between positions where each is either proximal or distal from the base (30) Independent operation of the ball screw drive mechanisms permits metal chip and shaving to be admitted into the chamber, compacted and subsequently discharged as compacted puck-like pellets Computer controls (162) operate the ball screw drive mechanisms and sense (182, 184, 186) operation of the compactor based on rotational positions of the screw drives of the ball screw drive mechanisms.

### BACKGROUND OF THE INVENTION

This invention relates to metal compacting apparatus, and particularly to metal compactors that compact incompressible metal shavings, chips and the like into easily transportable pellets, and remove cutting fluids from the metal, so that the cutting fluid and metal may be separately recycled.

U.S. Pat. Nos. 5,391,069 granted Feb. 21, 1995, 5,542,348 granted Aug. 6, 1996 and 5,664,492 granted Sep. 9, 1997, all assigned to the same Assignee as the present invention, describe a compactor that compacts metal chips and shavings into puck-like pellets that are free of interstices. Cutting fluid is extruded from the metal during the compacting process so that the resulting pellets are clean of cutting fluids. The compactor described in the aforementioned patents is commercially available as the PUCKMASTER® compactor, and is marketed primarily to machine shops and other metal-working operations where metal is processed by cutting, grinding and other processes. These metal-working processes use cutting fluids, such as cutting oil, to dissipate heat generated during the cutting or grinding process. The metal-working process results in scrap metal chips, shavings and the like that is laden with cutting oil. Machine shop operators use the PUCKMASTER compactor to recover nearly all of the cutting oil used in the metal-working process, as well as to compact the scrap metal into puck-like pellets that are free of cutting fluids. The machine shop can re-use the recovered cutting oils in subsequent metal-working operations, and can sell the metal pellets to reclamation foundries to recover raw metal material from the scraps. The foundries pay significantly higher prices for the pellets than for oil-laden metal chips and shavings because the cost of reclaiming the metal from the pellets is greatly reduced over that of reclaiming metal from oil-laden metal chips and shavings. Moreover, the cost of transportation of the pellets is significantly less than the cost of transporting the chips and shavings. Thus, the PUCKMASTER compactor provides savings to the machine shops in the form of (a) lower transportation costs for shipping the scrap metal to reclamation foundries, (b) higher prices received for the scrap metal due to its cleanliness, and (c) reduced costs in cutting fluids due to reclamation of the cutting fluid from the chips and shavings.

The PUCKMASTER compactor employs a compaction chamber into which the metal chips and shavings are introduced. A hydraulically-driven piston, capable of achieving pressures of 20,000 to 40,000 pounds per square inch (psi), compacts the metal chips and shavings. The high pressure extrudes cutting fluid from the metal chips and shavings and compacts the chips and shavings into a pellet that is substantially free of interstices. The pellets have a generally cylindrical shape, with a diameter between 2.5 and 4.5 inches (6.3 and 11.4 cm) depending on the diameter of the compaction chamber, and a thickness between 1 and 2 inches (2.5 and 5.1 cm) depending on the volume of chips and shavings in the compaction chamber during compaction. The pellets are known in the trade as “pucks” due to their vague resemblance to hockey pucks.

The PUCKMASTER compactors require high technical skill in several disciplines to service or refurbish the machine. More particularly, the PUCKMASTER compactors employ hydraulic drive mechanisms (hydraulic circuits, regulators, valves, pumps, and the like). While the hydraulic drive mechanisms of the prior compactors operated quite well in the field, technicians skilled in hydraulics were required to repair or refurbish those machines. Moreover, the PUCKMASTER compactors also employ computer control technology that operate the hydraulic valves and electric sensors, and employ electric power technology to operate the hydraulic pumps and computer. It was not always possible to find technicians skilled in all three disciplines of hydraulic, computer and electric power. Consequently, it was often necessary to send a team of as many as three technicians to customer sites for on-site repair and refurbishment.

Recent developments in ball-screw drive technology have made it feasible to achieve the operating pressures necessary to compact the metal chips and shavings as in the PUCKMASTER compactor. Moreover, use of electric ball-screw drive systems renders the compactor more economic to manufacture and assemble, and more economical to repair and refurbish. Therefore, the present invention is directed to a metal compactor employing a ball-screw drive.

### SUMMARY OF THE INVENTION

A compactor according to a preferred embodiment of the present invention is adapted to compact fluid-laden incompressible metal chips and shavings into puck-like pellets for separate reclamation of the metal and fluid. The compactor comprises a frame having a base. A compaction housing defines a compaction chamber. A compaction piston extends through an end of the compaction housing and has a working surface in the compaction chamber. An inlet in the wall of the compaction housing allows metal chips and shavings to be admitted into the compaction chamber. A ball screw drive mechanism has a motor supported by the frame to move the compaction housing along an axis between a first position where an open end of the compaction chamber is distal from the base and a second position where the open end is closed by the base. A second ball screw drive mechanism, has a motor supported by the frame to move the compaction piston along the axis between a first position where the working surface of the compaction piston is distal from the base and a second position where the working surface is proximal to the base.

The compactor operates such that when the working surface of the piston is distal from the base and the compaction chamber is closed by the base, metal chips and shavings may be admitted through the inlet opening into the compaction chamber. When the piston is moved to its position proximal the base, the piston closes the inlet and compacts the metal in the chamber against the base into a puck-like pellet. When the compaction housing is thereafter moved to its position distal from the base, the piston discharges the pellet from the compaction chamber.

### BRIEF DESCRIPTION OF THE DRAWINGS

FIG. 1 is a partly cutaway perspective view of a metal compactor according to the presently preferred embodiment of the present invention.

FIG. 2 is a top view of the metal compactor illustrated in FIG. 1 with the compaction piston in a load position.

FIG. 3 is a top view of the metal compactor as in FIG. 2 with the compaction piston in a compaction position. FIG. 4 is a partly cutaway frontal view of the metal compactor.

FIGS. 5 and 6 are top views of the right end portion of the metal compactor as illustrated in FIG. 2 with the compaction housing in compaction and discharge positions, respectively.

FIG. 7 is a partly cutaway perspective view of the metal compactor illustrating the feed mechanism and connection to an inlet hopper.

FIG. 8 is a block diagram of the control system for the metal compactor illustrated in FIGS. 1-7.

FIG. 9 is a flow diagram of the process of operation of the metal compactor to compact metal chips and shavings into puck-like pellets.

### DETAILED DESCRIPTION OF THE PREFERRED EMBODIMENTS

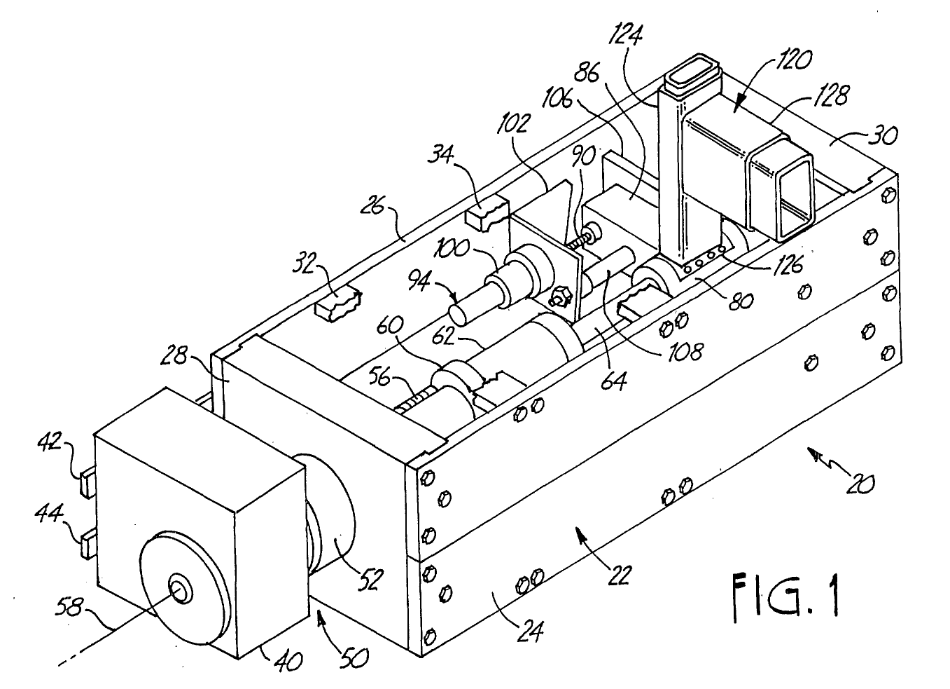

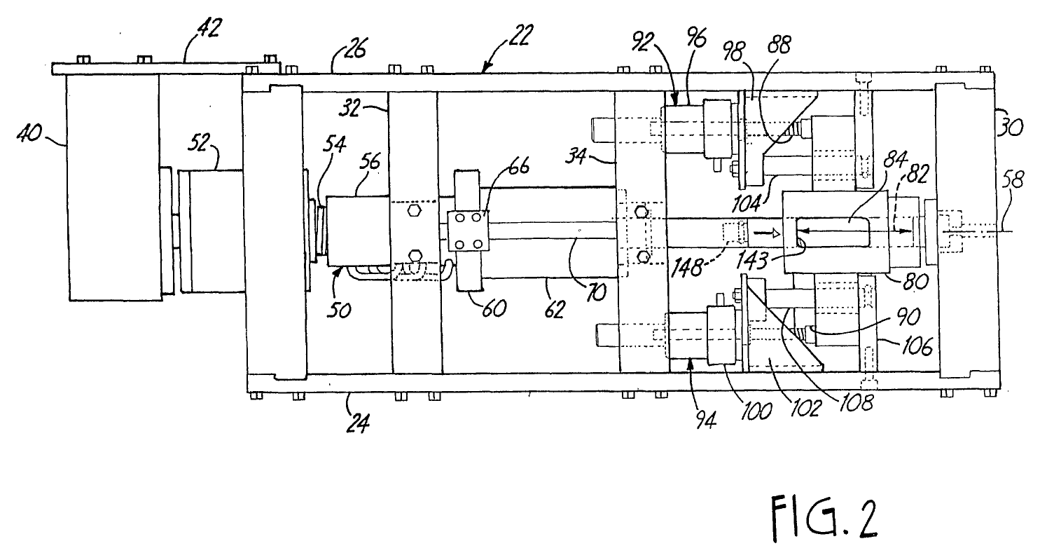

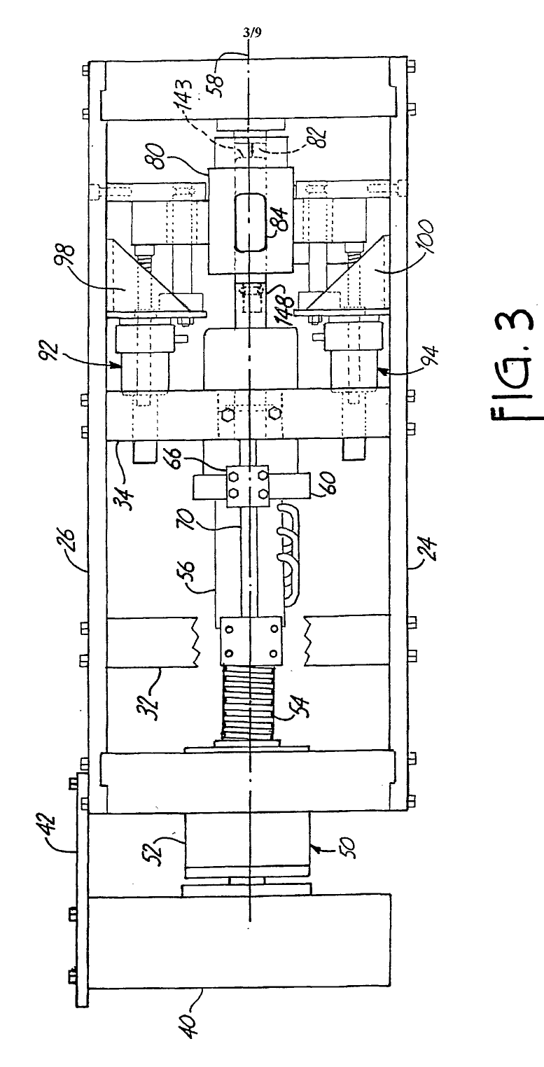

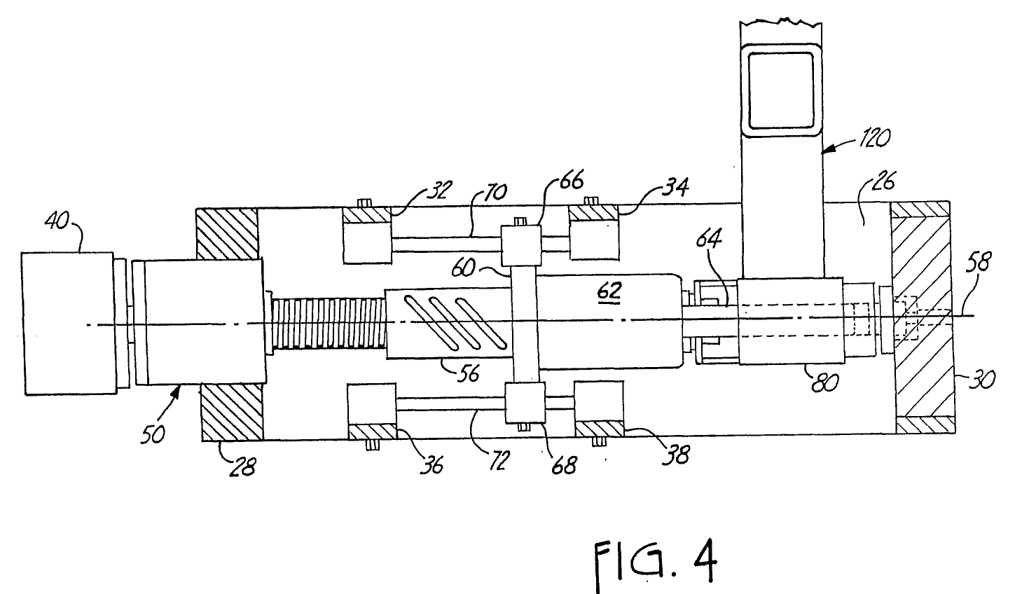

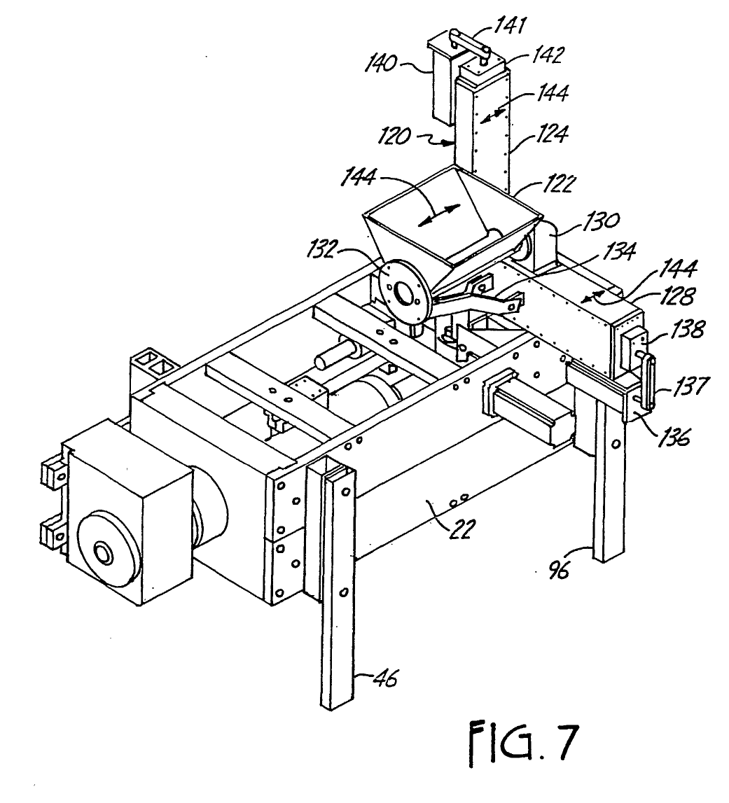

FIGS. 1-6 illustrate a metal compactor 20 having a support structure frame 22 consisting of side members 24 and 26, end member 28, base member 30, cross beams 32, 34 across the top of compactor 20, and cross beams 36 and 38 across the bottom of compactor 20. Frame 22 further includes a brace 40 mounted by straps 42 and 44 to side member 26. Frame 22 is preferably constructed of steel or other rigid metal, with the members and beams bolted together to form rigid frame 22. A skin or metal cover (not shown) is fastened over frame 22 to enclose the mechanisms and parts supported within the frame. As shown particularly in FIG. 7, frame 22 is supported by legs 46.

Ball screw drive mechanism 50 comprises an electric drive motor 52, screw drive 54 and coupling 56. Coupling 56 is coupled to the threads of screw drive 54 by a ball and race assembly well known in the art so that coupling 56 moves axially along axis 58 as screw drive 54 is rotated by motor 52. Motor 52 is reversible to rotate screw drive 54 in opposite directions about axis 58 to move coupling 56 to the right or left along axis 58 depending on the direction of rotation of screw drive 56. Member 60 couples coupling 56 to piston housing 62, which in turn is coupled to piston 64. As shown particularly in FIG. 4, member 60 is journaled by journals 66 and 68 to shafts 70 and 72. The ends of shafts 70 and 72 are mounted to respective cross beams 32, 34, 36 and 38 of frame 22 to extend parallel to axis 58. Hence, rods 70 and 72 serve as a guide to assure correct movement of piston 64.

Compaction housing 80 forms an internal compaction chamber 82 having an opening 84 through a wall of housing 80 forming an inlet for metal chips and shavings to be compacted. Compaction housing 80 is open at opposite ends along axis 58 and is mounted to frame 86 which in turn is coupled by a ball and race assembly to screw drives 88 and 90 of ball screw drive actuators 92 and 94. Ball screw actuator 92 includes an electric motor 96 mounted to frame 98, which in turn is mounted to wall 24 of frame 22. Motor 96 is operated to rotate screw drive 88. Similarly, ball screw actuator 94 includes electric motor 100 mounted to frame 102, which in turn is mounted to wall 26 of frame 22, to rotate screw drive 90. Ball screw actuators 92 and 94 are positioned parallel to axis 58 so that operation of motors 96 and 100 moves frame 86 axially, thereby moving compaction housing 80 along axis 58. Ball screw actuators 92 and 94 operate in unison to move housing 80 to the right or left along axis 58. Guide rod 104 is mounted between frame 98 and frame 106, and guide rod 108 is mounted between frame 102 and frame 106. Guide rods 104 and 108 are journaled to frame 86 to guide movement of housing 80. Frame 106 includes an aperture 110 through which housing 80 passes.

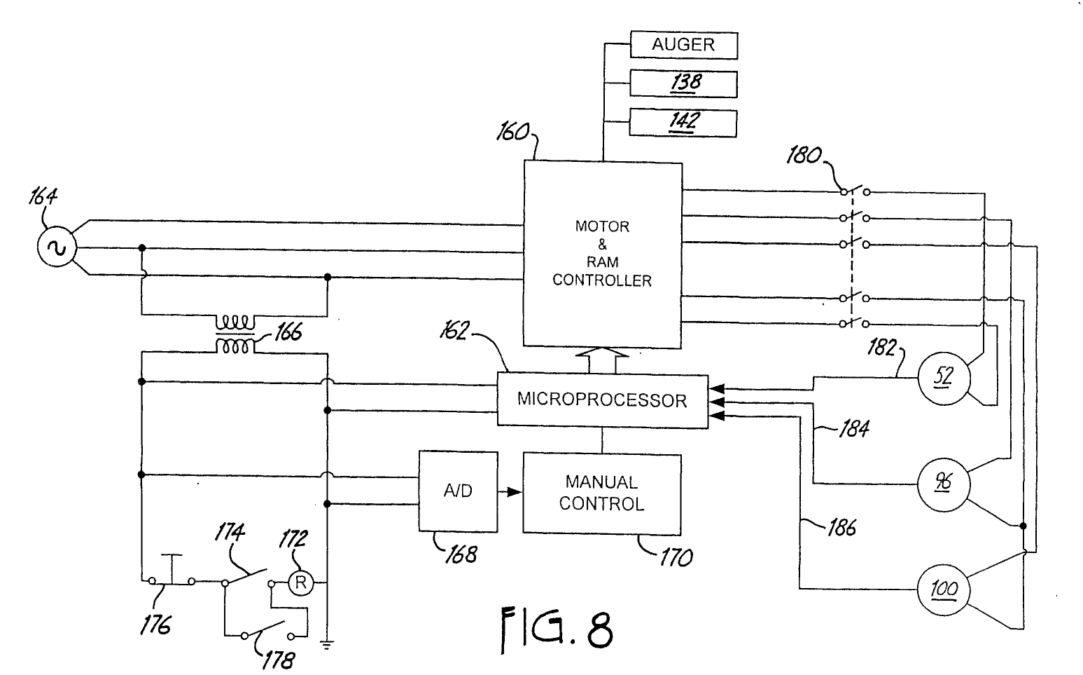

In preferred forms of the invention, motor 52 is a model MPM190 eight-inch electric motor and motors 96 and 100 are model MPM114 four-inch electric motors, each commercially available from Custom Servo Motors, Inc. of New Ulm, Minn., USA. One feature of motors 52, 96 and 100 is the inclusion of feedback lines that provide sine and cosine signals representative of the rotational position of the motor shafts of the respective motors. These signals are used for positional data and controlling operation of the compactor, as will be explained in connection with FIG. 8.

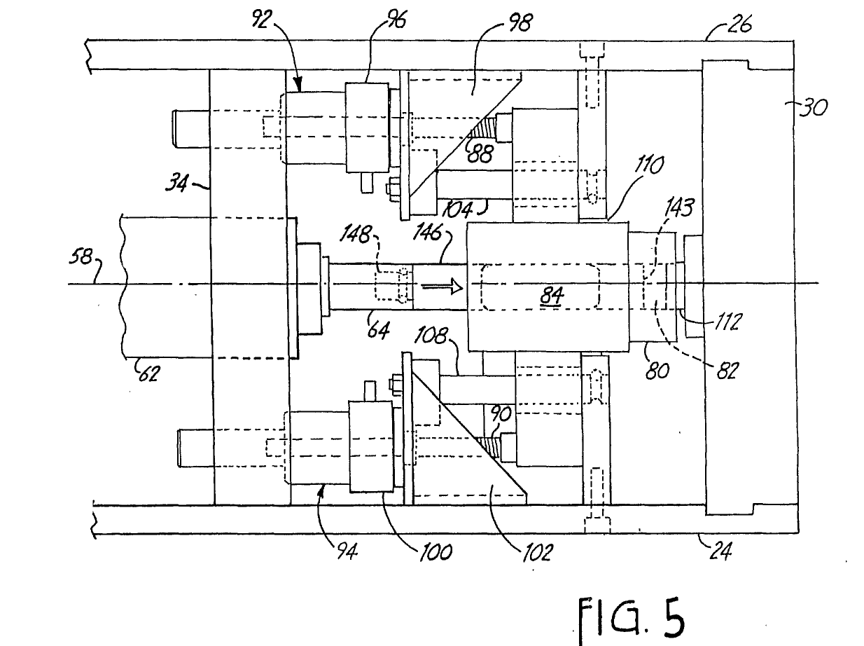

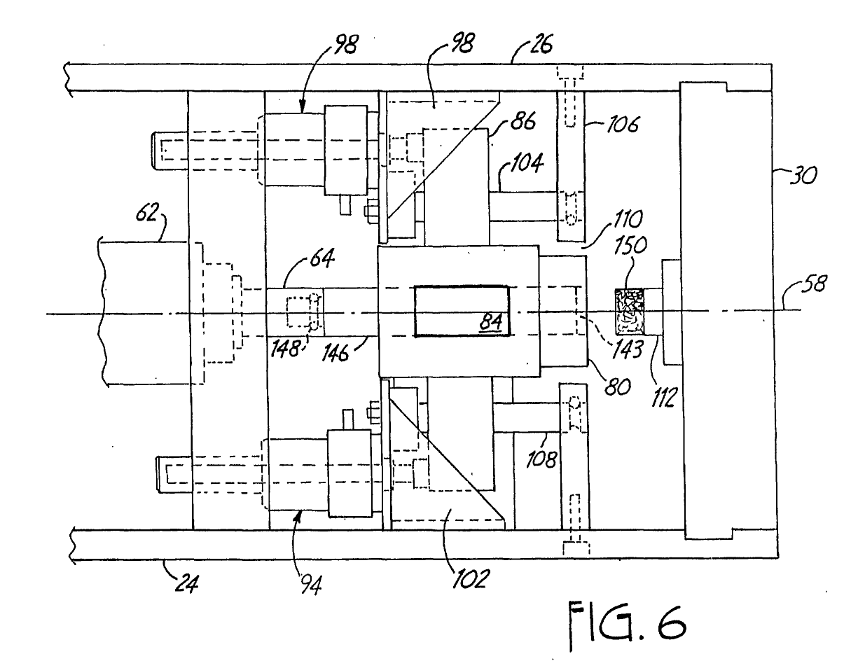

As shown particularly in FIGS. 5 and 6, piston 64 may include a replaceable piston member 146 that extends through the open end of compaction chamber 82, with a working surface 143 that engages and compacts the metal chips and shavings in the compaction chamber during operation. A coupling 148 couples member 146 to piston 64 to permit replacement of piston member 146. This feature is particularly advantageous because the compaction process is typically performed applying a pressure on the metal chips and shavings up to about 50,000 pounds per square inch (psi) (about 3,500 Kg/cm²). The piston is susceptible of wear, and even failure, when subjected to numerous cycles of such pressure. Consequently, a worn or failed piston member is easily replaced in the compactor described herein.

Base member 30 includes a raised pedestal 112 of a size and shape to be received through the lower opening of compaction chamber 82. A small clearance between pedestal 112 and housing 80 permits housing 80 to move over pedestal 112, and permits extruded cutting fluids to pass through the clearance from compaction chamber 82. A clearance of about 0.020 inches (0.5 mm) is adequate to permit discharge of cutting fluids without allowing metal to escape from the compaction chamber. Fluids expelled from the compaction chamber drop by gravity to a recovery receptacle (not shown) below the compactor to permit extruded cutting fluid to be removed and recovered.

FIG. 7 illustrates the details of feed mechanism 120 that feeds metal chips and shavings into compaction chamber 82 of compaction cylinder 80 from inlet hopper 122. Feed mechanism 120 includes a first conduit 124 fastened by flange 126 to compaction cylinder 80 (FIG. 1). Conduit 124 communicates with chamber 82 through inlet 84. A second conduit 128, parallel to axis 58, is mounted to conduit 124. An elbow conduit 130 extends into the bottom of hopper 122 to receive metal chips and shavings from the hopper and is rigidly mounted to hopper 122, such as by welding or the like to prevent leakage of fluid from hopper 122. An auger (not shown) in hopper 122 is operated by a motor mounted to flange 132 to transport metal chips and shavings to elbow conduit 130. Elbow conduit 130 supplies the metal chips and shavings to conduit 128. Preferably, mounts 134 fasten hopper 122 to conduit 128 so that hopper 122 is supported by the conduit.

Motor 136 is supported by one of legs 46 and includes a belt 137 coupled to ram 138 in conduit 128. Ram 138 supplies the metal chips and shavings in conduit 128 to conduit 124. Motor 140 includes a belt 141 to drive ram 142 in conduit 124 to transport metal chips and shavings in conduit 124 through inlet 84 into compaction chamber 82. Hence, metal chips and shavings in hopper 122 enter conduit 130 and are transported by ram 138 to conduit 124 where they are forced by ram 142 through inlet 84 to the compaction chamber where they are compacted.

During operation of the metal compactor, compaction cylinder 80 is moved horizontally along axis 58 by ball screw actuators 92 and 94. During this movement, feed mechanism 120 also moves horizontally, as indicated by arrows 144. Consequently, hopper 122 and conduits 124, 128 and 130 move with motion of cylinder 80. In preferred embodiments, the maximum movement of cylinder 80 is about 4 inches (10 cm) so feed mechanism 122 moves the same distance.

The operation of the metal compactor may best be explained starting with compaction cylinder 80 in its right-most position so the end of compaction chamber 82 is closed over pedestal 112, and piston 64 in a withdrawn position (to the left in the drawings) so that piston 64 is free of inlet 84 of compaction cylinder 80 (FIG. 2) and the inlet is open. Ram 142 is operated to load metal chips and shavings into chamber 82 from conduit 124. Ram 142 effectively delivers a load of metal chips and shavings to compaction chamber 82 and closes inlet 84 when the camber is loaded. Hence, when ram 142 reaches a design limit, the ram effectively closes inlet 84 to compaction chamber 82.

Ball screw actuator 50 is operated to move piston 64 along axis 58 (to the right in the drawings) to compact metal chips and shavings in the compaction chamber 82 between surface 143 of the piston and pedestal portion 112 of the base. During the initial portion of the compaction operation, the compaction pressure on the metal chips and shavings increases due to the movement of piston 64. Additionally, when piston 64 is moved to a position closing inlet 84, chips and shavings are prevented from being expelled back into conduit 124. As the piston moves to a compacting position, between about 1 and 2 inches (2.5 and 5.1 cm) from pedestal 112, the metal chips and shavings are compacted within chamber 82 into the puck-like pellets 150 (FIG. 6). The compaction position of piston 64 is established based on the size of the metal compactor and the type of metal being compacted. As described below, the design lower limit of piston 64 is programmed into microprocessor 162 (FIG. 8) controlling operation of the metal compactor and may be changed by the operator to accommodate various metals.

During the compaction of the metal chips and shavings into pucks 150, excess cutting fluid or oil is extruded from the interstices of the chips and shavings and forced out of compaction chamber 82 through the clearance between cylinder 80 and pedestal 112. The extruded cutting fluid drains to a collection receptacle (not shown) below the compactor for re-use.

When ball screw actuator 50 has moved piston 64 to its compaction position, the compaction process is completed and the metal in chamber 82 is completely compacted to form puck 144. Additional metal chips and shavings are loaded into conduit 128, and ram 138 transports the chips and shavings to conduit 124.

Ball screw actuators 92 and 94 are operated to withdraw or retract cylinder 80 to the left. Piston 64 remains in its right-most position so that as cylinder 80 is withdrawn, piston 64 forces the compacted puck 1150 from chamber 82. Ball screw actuator 50 is then operated to withdraw or retract piston 64 to its left-most position (FIG. 6), and the finished puck 150 falls free from pedestal 112 to a collection bin (not shown) where it may be collected for eventual reclamation or recycling.

Finally, ball screw actuators 92 and. 94 are operated to move cylinder 80 to its right-most position engaging pedestal 112, and the process is repeated.

FIG. 8 is a block circuit diagram of the electronic controls for operating the metal compactor illustrated in FIGS. 1-7. Broadly, controller 160 selectively applies power to motors 52, 96 and 100, which in turn provide position signals to microprocessor 162 to control operation of controller 160. In addition, controller 160 operates the hopper auger motor coupled to flange 132 (FIG. 7) as well as rams 138 and 142. Three-phase power, such as 450 volt, three-phase AC power, is supplied by source 164, which may be an industrial power source supplied by a commercial power company. The three phases of the power source are applied to controller 160. Step-down transformer 166 is coupled to two of the phases from source 164 to supply 120-volt single-phase AC power to microprocessor 162 and to analog-to-digital power supply 168, which in turn supplies DC power to manual control 170. Power relay 172 is coupled across the 110 volt supply from transformer 166 through normally open push-button switch 174 and normally closed push-button switch 176. Relay 172 operates contacts 178 and 180 when energized. When push-button switch 174 is momentarily operated, relay 172 is energized to close contacts 178 and 180. Closing of contacts 178 ensures that relay 172 remains energized during operation of the compactor. Closure of contacts 180 ensures delivery of power to motors 52, 96 and 100. Shut-down of the compactor is achieved by operating push-button switch 176 to de-energize relay 172, thereby opening contacts 178 and 180 and removing power from motors 52, 96 and 100.

As described above, motors 52, 96 and 100 provide signals via respective lines 182, 184 and 186 representative of the respective angular position of the shafts of each of the respective motors 52, 96 and 100, and hence the angular position of ball screw drive threads 54, 88 and 90 of the associated ball screw actuator. The signals, which are representative of the sine and cosine functions of the angular position of the respective shafts, are input to microprocessor 162. Microprocessor 162 is programmed to respond to sine/cosine signals on leads 182, 184 and 186 to control operation of motors 52m 96 and 100 and rams 138 and 140, based on the position of the respective ball screw actuators. Hence, the positions of piston 64 and compactor housing 80 are sensed by motors 52, 96 and 100 to control operation of the compactor as programmed by microprocessor 162.

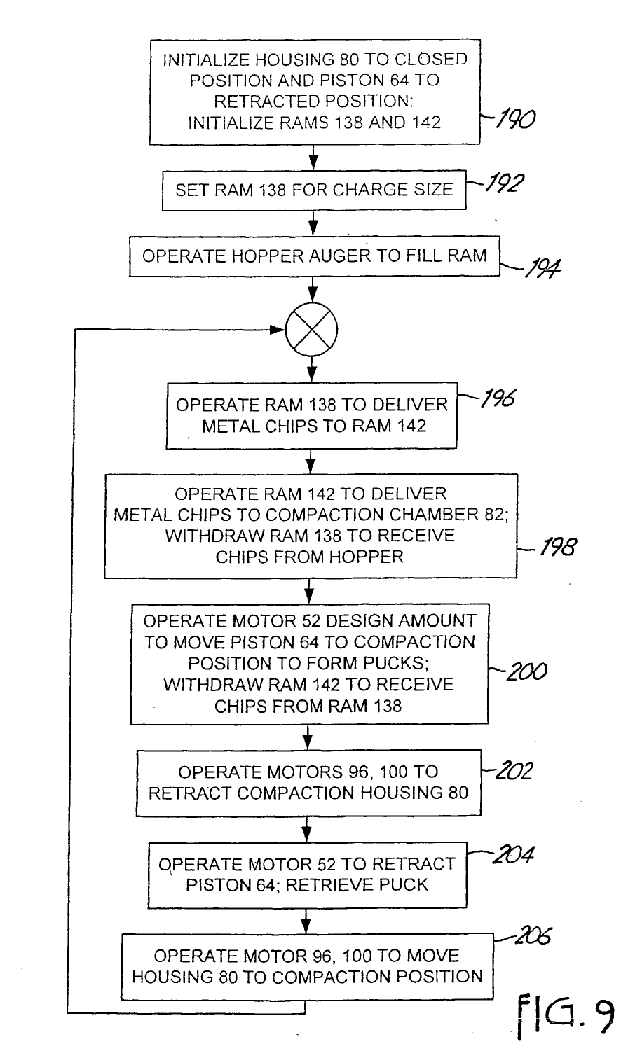

Microprocessor 162 is programmed to operate controller 160 to selectively advance or retract piston 64 and compaction housing 80, and to operate the respective ram 138 and 142 and the auger in hopper 122. More particularly, as more fully described in connection with the flow chart of FIG. 9, the position feedback on line 182 represents the position of compaction pistion 64. When piston 64 is moved to its retracted position, as sensed by the signal on line 182, microprocessor 162 controls controller 160 to operate motors 96 and 100 to move compaction housing 80 to the compaction postion. When housing 80 reaches the compaction position closing the open end of the compaction chamber to pedestal 112, as sensed by the signals on lines 184 and 186, microprocessor 162 controls controller 160 to operate ram 138 to deliver metal chips and shavings to ram 142 and subsequently operate ram 142 to deliver metal chips and shavings to compaction the chamber while withdrawing or retracting ram 138, and, after a programmed delay, to operate motor 52 to move compaction pistion 64 to the compaction postion to form the pucks. When piston 64 reaches the compaction position at a programmed distance from pedestal 112, as sensed by the signals on line 182, microprocessor 162 controls controller 160 to retract ram 142 and to to operate motors 96 and 100 to move compaction housing 80 to the retracted postion to release the pucks. When compaction housing 80 reaches the compaction position, as sensed by the signals on line 184 and 186, microprocessor 162 controls controller 160 to operate motor 52 to move compaction piston 64 to its retracted postion.

Manual control 170 permits manual initialization of the compactor as well as to independently operate the piston and compaction housing to their respective positions. Manual control 170 additionally allows programming the retracted position of ram 138 and the compaction position of piston 64 to permit different sized puck thicknesses for different metals being compacted.

FIG. 9 is a flow chart illustrating the process performed by microprocessor 162. At step 190, the position of compaction housing 80 and piston 64 are initialized such that compaction housing 80 is in its closed position over at pedestal 112 and piston 64 is in its retracted position to allow a charge of metal chips and shavings to be input through inlet 84. At step 192, the initial or retracted position of ram 138 is established, based on the type of metal being compacted and the size of the pucks to be formed. At step 194, the hopper auger is operated to deliver metal chips and shavings from hopper 122 to ram 138. In some cases, it may be desirable to operate the auger continuously, even when ram 138 is in its delivery position and chips and shavings can not enter the ram. Otherwise, the hopper auger may be operated only when ram 138 is retracted to a position able to receive chips from the hopper. In either case, at step 196, ram 138 is operated to deliver metal chips and shavings to ram 142 and ram 142 is operated at step 198 to delivery the metal chips and shavings to compaction chamber 82. Also, ram 138 is retracted or withdrawn so as to receive an additional charge of chips from hopper 122. The withdrawn position of ram 138 is sized, based on the metal being compacted and the size of the puck to be formed.

The compaction process begins at step 200 with the operation of motor 52 to move piston 64 to the compaction position to form pucks 150 in compaction chamber 82 and against pedestal 112. At the same time, ram 142 is withdrawn to receive metal chips and shavings from ram 138. At step 202, motors 96 and 100 are operated to retract compaction housing 80 forcing puck 150 from the housing compaction chamber. At this point, puck 150 is sandwiched between pedestal 112 and piston 64. At step 204, motor 52 is operated to retract piston 64 and allowing puck 150 to drop free to the receiving receptacle (not shown). At step 206, motors 96 and 100 are operated to move compaction housing 80 back to its compaction position against pedestal 112, and the process repeats, commencing at step 196.

The present invention thus provides a metal compaction apparatus for compacting metal chips and shavings into puck-like pellets for recycling, and for retrieving cutting fluids from the metal chips and shavings, also for recycling. In the preferred form of the invention, ball screw actuators are employed to independently move the compaction piston and compaction housing for operation. Feedback from the compaction motors allows precise sensing of the position of both the compaction piston and the compaction housing during operation to control the process. In addition, in the unlikely event that motors 96 and 100 become skewed, any mis-alignment of the motors is quickly sensed by the feedback to microprocessor 162 to allow controller 160 to correct the angular position of the motor shafts.

Although the present invention has been described with reference to preferred embodiments, workers skilled in the art will recognize that changes may be made in form and detail without departing from the spirit and scope of the invention.

What is claimed is:

1. A compactor for compacting fluid-laden incompressible metal chips and shavings comprising, in combination:
a support structure having a base;
a compaction housing defining a compaction chamber having an axis and an axially disposed open end;
a compaction piston in the compaction chamber, the compaction piston having a working surface in the compaction chamber;
an inlet through a wall of the compaction housing in communication with the compaction chamber;
an inlet conduit mounted to the compaction housing and coupled to the inlet for delivering metal chips and shavings to the compaction chamber;
a hopper coupled to the inlet conduit for supplying metal chips and shavings to the inlet conduit;
a first drive mechanism supported by the support structure to move the compaction housing along the axis between a first position where the open end of the compaction chamber is separated from the base and a second position where the open end is closed by the base; and
a second drive mechanism supported by the support structure to move the compaction piston along the axis between a first position where the working surface of the compaction piston is separated from the base to permit metal chips and shavings to be admitted through the inlet into the compaction chamber when the compaction housing is in its second position and a second position where the compaction piston closes the inlet and the working surface is in close proximity to the base,
whereby the compaction piston compacts metal chips and shavings in the compaction chamber when the compaction housing is in its second position and the compaction piston is moved to its second position, and the compaction piston discharges a compacted puck-like pellet from the compaction chamber when the compaction piston is in its second position and the compaction housing is moved to its first position.

2. The compactor of claim 1, wherein the first and second drive mechanisms are ball screw drives.

3. The compactor of claim 1, including a frame supporting the compaction housing, the first drive mechanism comprising first and second ball screw drives each having a motor and a screw drive, one of the motor and screw drive of each of the first and second ball screw drives being supported by the support structure and the other of the motor and screw drive of each of the first and second ball screw drives being supported by the frame.

4. The compactor of claim 3, including a guide rod mounted to the support structure parallel to the axis and journaled to the frame.

5. The compactor of claim 3, wherein the motor of each of the first and second ball screw drives is mounted to the support structure and the screw drive of each of the first and second ball screw drives is coupled to the frame.

6. The compactor of claim 5, wherein the screw drives of the first and second ball screw drives are coupled to the frame on opposite sides of the compaction housing.

7. The compactor of claim 3, wherein the second drive mechanism is a third ball screw drive having a motor supported by the support structure and a screw drive coupled to the piston.

8. The compactor of claim 1, wherein the base includes a pedestal arranged to extend into the compaction chamber through the open end when the compaction housing is in its second position.

9. The compactor of claim 1, including a ram for forcing metal chips and shavings in the inlet conduit through the inlet and into the compaction chamber.

10. The compactor of claim 1, wherein the inlet conduit is movable in a direction parallel to the axis with the compaction housing.

11. The compactor of claim 1, including a microprocessor coupled to the first and second drive mechanisms, the microprocessor being programmed so that with the compaction housing initially in its second position and the compaction piston initially in its first position so that metal chips and shavings may be admitted into the compaction chamber through the inlet, the microprocessor:
a) operates the second drive mechanism to move the compaction piston from its second to its first position to compact the metal chips and shavings in the compaction chamber into a solid puck-like pellet and to extrude fluid from the metal chips and shavings in the compaction chamber,
b) after step (a), operates the first drive mechanism to move the compaction housing from its second to its first position so that the compaction piston urges the puck-like pellet through the open end of the compaction chamber, and
c) after step (b) , operates the second drive mechanism to move the compaction piston from its first to its second position.

12. The compactor of claim 11, wherein the microprocessor is further programmed to
d) after step (c), operate the first drive mechanism to move the compaction housing from its first to its second position to close the open end of the compaction chamber so that additional metal chips and shavings may be admitted into the compaction chamber through the inlet.

13. The compactor of claim 12, wherein the microprocessor is further programmed to repeat steps (a) to (d).

14. The compactor of claim 13, wherein
the first drive mechanism comprises:
a frame coupled to the compaction housing,
a first electric motor supported by the support structure,
a first screw drive coupled to the first motor for rotation about a first axis,
a first coupling connected to the frame and threadably coupled to the first screw drive for movement along the first axis upon rotation of the first screw drive, and
a first feedback coupled to the first electric motor providing first position signals representative of a rotational position of the first screw drive, and
the second drive mechanism comprises:
a second electric motor supported by the support structure,
a second screw drive coupled to the second motor for rotation about a second axis parallel to the first axis,
a second coupling connected to the piston and threadably coupled to the second screw drive for movement along the second axis upon rotation of the second screw drive, and
a second feedback coupled to the second electric motor providing second position signals representative of a rotational position of the second screw drive,
the microprocessor being programmed to respond to the first and second position signals to control operation of the first and second drive mechanisms.

15. The compactor of claim 14, wherein the first drive mechanism further includes:
a third electric motor supported by the support structure,
a third screw drive coupled to the third motor for rotation about a third axis parallel to the second axis,
a third coupling connected to the frame opposite the second coupling and threadably coupled to the third screw drive for movement along the third axis upon rotation of the third screw drive, and
a third feedback coupled to the third electric motor providing third position signals representative of a rotational position of the third screw drive,
the microprocessor being further programmed to
respond to the third position signals to control operation of the second drive mechanism.

16. The compactor or claim 15, including a guide rod mounted to the support structure parallel to the axis and journaled to the frame.

17. A compactor for compacting fluid-laden incompressible metal chips and shavings comprising, in combination:
a support structure having a base;
a compaction housing defining a compaction chamber having an axis and an axially disposed open end;
a compaction piston in the compaction chamber, the compaction piston having a working surface in the compaction chamber;
an inlet through a wall of the compaction housing for admitting metal chips and shavings into the compaction chamber;
a first drive mechanism supported by the support structure to move the compaction housing along the axis between a first position where the open end of the compaction chamber is separated from the base and a second position where the open end is closed by the base;
a second drive mechanism supported by the support structure to move the compaction piston along the axis between a first position where the working surface of the compaction piston is separated from the base to permit metal chips and shavings to be admitted through the inlet into the compaction chamber when the compaction housing is in its second position and a second position where the compaction piston closes the inlet and the working surface is in close proximity to the base; and
a microprocessor coupled to the first and second drive mechanisms, the microprocessor being programmed so that with the compaction housing initially in its second position and the compaction piston initially in its first position so that metal chips and shavings may be admitted into the compaction chamber through the inlet, the microprocessor:
a) operates the second drive mechanism to move the compaction piston from its second to its first position to compact the metal chips and shavings in the compaction chamber into a solid puck-like pellet and to extrude fluid from the metal chips and shavings in the compaction chamber,
b) after step (a), operates the first drive mechanism to move the compaction housing from its second to its first position so that the compaction piston urges the puck-like pellet through the open end of the compaction chamber, and
c) after step (b), operates the second drive mechanism to move the compaction piston from its first to its second position.

18. The compactor of claim 17, wherein the microprocessor is further programmed to
d) after step (c), operate the first drive mechanism to move the compaction housing from its first to its second position to close the open end of the compaction chamber so that additional metal chips and shavings may be admitted into the compaction chamber through the inlet.

19. The compactor of claim 18, wherein
the first drive mechanism comprises:
a first electric screw drive coupled to the compaction chamber, and
a first feedback coupled to the first electric screw drive providing first position signals representative of a rotational position of the first electric screw drive, and
the second drive mechanism comprises:
a second electric screw drive coupled to the piston, and
a second feedback coupled to the second electric screw drive providing second position signals representative of a rotational position of the second electric screw drive,
the microprocessor being programmed to respond to the first and second position signals to control operation of the first and second drive mechanisms.

20. The compactor of claim 19, wherein the first drive mechanism further includes:
a third electric motor supported by the support structure,
a third screw drive coupled to the third motor for rotation about a third axis parallel to the second axis,
a third coupling connected to the frame opposite the second coupling and threadably coupled to the third screw drive for movement along the third axis upon rotation of the third screw drive, and
a third feedback coupled to the third electric motor providing third position signals representative of a rotational position of the third screw drive,
the microprocessor being further programmed to respond to the third position signals to control operation of the second drive mechanism.
